(19) United States
(12) Patent Application Publication
(10) Pub. No.: US 2026/0095610 A1
(43) Pub. Date: Apr. 2, 2026

(54) VIDEO DISTRIBUTION SYSTEM, VIDEO DISTRIBUTION METHOD, AND VIDEO DISTRIBUTION PROGRAM

(71) Applicant: HONDA MOTOR CO., LTD., Tokyo (JP)

(72) Inventors: Kenta Maruyama, Tokyo (JP); Yuta Nishizawa, Tokyo (JP); Yusuke Ishida, Tokyo (JP); Junichiro Onaka, Tokyo (JP)

(21) Appl. No.: 19/339,355

(22) Filed: Sep. 25, 2025

(30) Foreign Application Priority Data
Sep. 30, 2024 (JP) 2024-170272

(51) Int. Cl. H04N 21/414; G05D 1/224; H04N 21/218; H04N 21/44

(52) U.S. Cl. CPC H04N 21/41407; G05D 1/2247; H04N 21/2181; H04N 21/44

(57) ABSTRACT

A video distribution system of an embodiment is a video distribution system that includes: a plurality of movable body devices mounted on a movable body on which an occupant boards; a user device that is used by a user at a location which is different from that of the movable body; and a communication network that communicably connects the plurality of movable body devices to the user device, and distributes a video from the plurality of movable body devices to the user device, wherein each of the plurality of movable body devices distributes a plurality of videos to the user device by an individual line, and the user device performs a combination process of the plurality of videos distributed from the plurality of movable body devices and generates a composition video.

### CROSS-REFERENCE TO RELATED APPLICATION

Priority is claimed on Japanese Patent Application No. 2024-170272, filed on September 30, 2024, the contents of which are incorporated herein by reference.

### BACKGROUND

### FIELD OF THE INVENTION

The present invention relates to a video distribution system, a video distribution method, and a video distribution program.

### BACKGROUND

Research has been advanced on a remote operation system that can achieve both maintenance of a sense of immersion and reduction of a communication load when moving at a high speed (for example, refer to Japanese Unexamined Patent Application, First Publication No. 2019-134383). This remote operation system includes a plurality of omnidirectional cameras, and by combining videos of the omnidirectional cameras, a global video, a hemispherical video, or a 360-degree band video is displayed. Further, resolution with respect to part of the entire region of an omnidirectional image of imaging data is decreased in a step-by-step manner or continuously gradually at a position further away from a sight line region, and thereby, the remote operation system decreases a communication amount.

### SUMMARY

Since such a remote operation system transmits imaging data of the plurality of omnidirectional cameras via a single communication line, part of the entire region of the omnidirectional image is reduced in resolution and is displayed on a head-mounted display. That is, in the background art described above, there is a problem that a video displayed at a distributed side is delayed since an image quality reduction process of the imaging data is required.

An object of the present application is to provide a video distribution system, a video distribution method, and a video distribution program that can prevent delay of a video displayed at a distributed side.

A first aspect of the present invention is a video distribution system that includes: a plurality of movable body devices mounted on a movable body on which an occupant boards; a user device that is used by a user at a location which is different from that of the movable body; and a communication network that communicably connects the plurality of movable body devices to the user device, and distributes a video from the plurality of movable body devices to the user device, wherein each of the plurality of movable body devices distributes a plurality of videos to the user device by an individual line, and the user device performs a combination process of the plurality of videos distributed from the plurality of movable body devices and generates a composition video.

A second aspect of the present invention is the video distribution system according to the first aspect described above, wherein the movable body devices may acquire the plurality of videos in which an imaging direction does not overlap each other.

A third aspect of the present invention is the video distribution system according to the first or second aspect described above, wherein the plurality of videos may have an image quality that is identical to or different from each other.

A fourth aspect of the present invention is the video distribution system according to the first or second aspect described above, wherein the user device may be a head-mounted display in which a visual recognition direction is freely designated.

A fifth aspect of the present invention is the video distribution system according to the fourth aspect described above, wherein the movable body devices may distribute the video corresponding to the visual recognition direction acquired from the head-mounted display.

A sixth aspect of the present invention is the video distribution system according to the fourth aspect described above, wherein the user device may decrease an image quality of the video that does not correspond to a front to be lower than an image quality of the video that corresponds to the front based on the visual recognition direction acquired from the head-mounted display.

A seventh aspect of the present invention is the video distribution system according to the first or second aspect described above, wherein the movable body devices may be a plurality of smartphones to which an identical ID (identification number) is given.

An eighth aspect of the present invention is a video distribution method that distributes a video from a movable body device mounted on a movable body on which an occupant boards to a user device that is used by a user at a location which is different from that of the movable body, the video distribution method including: acquiring a plurality of videos; and individually transmitting the plurality of videos by using a plurality of individual lines.

A ninth aspect of the present invention is a computer-readable non-transitory storage medium storing a video distribution program that causes a computer mounted on a movable body on which an occupant boards to distribute a video toward a user device that is used by a user at a location which is different from that of the movable body, wherein the video distribution program causes the computer to execute: acquiring a plurality of videos; and individually transmitting the plurality of videos by using a plurality of individual lines.

According to an aspect of the present invention, it is possible to provide a video distribution system, a video distribution method, and a video distribution program capable of preventing delay of a distribution video.

### BRIEF DESCRIPTION OF THE DRAWINGS

FIG. 1 is a system configuration view showing the configuration of a video distribution system according to an embodiment of the present invention.

FIG. 2 is a block diagram showing a detailed configuration of a movable body in the video distribution system.

FIG. 3 is a flowchart showing a video distribution method and a video distribution program according to the embodiment of the present invention.

FIG. 4 is a schematic view showing a movable body surrounding video in the distribution system.

FIG. 5A is a schematic view showing the sound image localization and the sound volume adjustment of a movable body voice in the distribution system.

FIG. 5B is a schematic view showing the sound image localization and the sound volume adjustment of the movable body voice in the distribution system.

FIG. 5C is a schematic view showing the sound image localization and the sound volume adjustment of the movable body voice in the distribution system.

### DESCRIPTION OF EMBODIMENTS

Hereinafter, an embodiment of a video distribution system, a video distribution method, and a video distribution program of the present invention will be described with reference to the drawings.

FIG. 1 is a system configuration view of a video distribution system A according to the present embodiment. The video distribution system A includes at least three movable body devices 1a, 1b, and 1c mounted on a movable body M on which an occupant P boards, a network N, and three user devices 2a, 2b, and 2c used by three users Ua, Ub, and Uc who are present at a location which is different from that of the movable body M, that is, a virtual drive experience place T.

The movable body M is an automobile provided for a simulation experience of each of the users Ua, Ub, and Uc and travels along an experience route that is set in advance. The occupant P is a moving image distributor (streamer) who performs driving of the movable body M and provides a video (distribution video) and the like required for the simulation experience of a drive that uses the movable body M to each of the users Ua, Ub, and Uc.

Each of the users Ua, Ub, and Uc is a drive simulation experience person who performs the simulation experience of the drive that uses the movable body M in the virtual drive experience place T that is different from the movable body M by using the video distribution system A. For example, the movable body M travels in a sightseeing spot, and thereby, each of the users Ua, Ub, and Uc can virtually experience a drive in the sightseeing spot without actually boarding on the movable body M. In the video distribution system A, the movable body M is a distribution side of simulation experience information, and the virtual drive experience place T is a distribution destination of the simulation experience information, that is, a distributed side.

In the present embodiment, three movable body devices 1a, 1b, and 1c are employed as an example of a plurality of movable body devices, and three user devices 2a, 2b, and 2c are employed as an example of a plurality of user devices. The number of movable body devices is not limited to three. Further, the number of user devices is not limited to three. Further, the number of users is not limited to three. Further, in the present embodiment, the number of movable body devices and the number of user devices are set to be the same as each other, but the number of movable body devices and the number of user devices may be different from each other. The user devices 2a, 2b, and 2c may be used in the same environment (for example, the virtual drive experience place T) or may be used in different environments, respectively (for example, at home or the like).

Each of the movable body devices 1a, 1b, and 1c is a portable terminal that includes at least an imaging function, a wireless communication function, and an external information acquisition function. Each of the movable body devices 1a, 1b, and 1c captures a plurality of videos relating to a surrounding of the movable body M as a movable body surrounding video and distributes a plurality of movable body surrounding videos individually to each of the user devices 2a, 2b, and 2c. That is, each of the movable body devices 1a, 1b, and 1c sets an individual communication line (individual line) with each of the user devices 2a, 2b, and 2c and individually distributes each movable body surrounding video as a distribution video by using each individual line.

Each of the movable body devices 1a, 1b, and 1c acquires a movable body surrounding video in which an imaging direction does not overlap each other. For example, a first movable body device 1a is provided so as to face a left side glass of the movable body M, a second movable body device 1b is provided so as to face a front glass of the movable body M, and a third movable body device 1c is provided so as to face a right side glass of the movable body M. Further, the individual line described above is not necessarily provided individually on each movable body device. For example, one individual line may be shared by a plurality of movable body devices.

A first movable body surrounding video Ga acquired by the first movable body device 1a represents a view on a left side of the movable body M. A second movable body surrounding video Gb acquired by the second movable body device 1b represents a view in front of the movable body M. A third movable body surrounding video Gc acquired by the third movable body device 1c represents a view on a right side of the movable body M. That is, in the first to third movable body surrounding videos Ga, Gb, and Gc, an imaging direction is different from each other.

Each of the movable body devices 1a, 1b, and 1c individually distributes the first to third movable body surrounding videos Ga, Gb, and Gc toward each of the user devices 2a, 2b, and 2c by using an individual line.

Each of the movable body devices 1a, 1b, and 1c includes a function of acquiring a voice which is one of external information as a movable body voice and distributing the sound to each of the user devices 2a, 2b, and 2c in addition to a distribution function of the movable body surrounding video to each of the user devices 2a, 2b, and 2c. Each of the movable body devices 1a, 1b, and 1c distributes the movable body surrounding video and the movable body voice to each of the user devices 2a, 2b, and 2c as drive simulation experience information.

Each of the movable body devices 1a, 1b, and 1c is a kind of computer and is, for example, a smartphone. Since the smartphone includes a so-called smartphone camera (imaging function) and can be used as each of the movable body devices 1a, 1b, and 1c of the present embodiment. Each of the movable body devices 1a, 1b, and 1c executes an application program (distribution program) stored in advance and thereby realizes the imaging function, the wireless communication function, the external information acquisition function, and the like.

Further, an identical ID (identification number) is given to each of the movable body devices 1a, 1b, and 1c.

Each of the movable body devices 1a, 1b, and 1c performs a communication with each of the user devices 2a, 2b, and 2c by using the identical ID (identification number), that is, a common ID.

The network N is a communication network that communicably connects the movable body devices 1a, 1b, and 1c to the user devices 2a, 2b, and 2c. The network N includes, for example, at least one of the Internet, a WAN (Wide Area Network), a LAN (Local Area Network), a mobile communication network, a cellular network, a high-speed satellite communication network, and the like. The network N transmits simulation experience information from each of the movable body devices 1a, 1b, and 1c to each of the user devices 2a, 2b, and 2c and transmits various requests (experience requests) relating to the drive simulation experience from each of the user devices 2a, 2b, and 2c to each of the movable body devices 1a, 1b, and 1c.

Each of the user devices 2a, 2b, and 2c is a portable terminal that includes at least a communication function, a display function, a sound generation function, and a sound collection function, and is provided corresponding to each of the users Ua, Ub, and Uc. That is, each of the user devices 2a, 2b, and 2c is used by each of the users Ua, Ub, and Uc. As shown in FIG. 1, a first user Ua uses a first user device 2a, a second user Ub uses a second user device 2b, and a third user Uc uses a third user device 2c.

Each of the user devices 2a, 2b, and 2c applies a combination process to each of movable body surrounding videos Ga, Gb, and Gc acquired from each of the movable body devices 1a, 1b, and 1c, thereby generates a composition video (combination video) G, and displays the composition video G. Further, each of the user devices 2a, 2b, and 2c individually pronounces the movable body voice acquired from each of the movable body devices 1a, 1b, and 1c. Further, each of the user devices 2a, 2b, and 2c transmits, to each of the movable body devices 1a, 1b, and 1c, an experience request relating to a simulation experience of a drive that is operated by and is input from each of the users Ua, Ub, and Uc.

Each of the user devices 2a, 2b, and 2c is, for example, a head-mounted display. That is, each of the user devices 2a, 2b, and 2c includes at least three basic functions of looking, listening, and speaking. Each of the user devices 2a, 2b, and 2c cooperates with each other and pronounces a voice captured by another movable body device in addition to the movable body voice delivered from each of the movable body devices 1a, 1b, and 1c, which will be described later in detail.

The video distribution system A according to the present embodiment includes a management server 3 in addition to the movable body devices 1a, 1b, and 1c, the network N, and the user devices 2a, 2b, and 2c. The management server 3 is communicably connected to each of the movable body devices 1a, 1b, and 1c and each of the user devices 2a, 2b, and 2c via the network N.

The management server 3 is a relay device that relays and aids a communication between the movable body devices 1a, 1b, and 1c and the user devices 2a, 2b, and 2c. The management server 3 includes, for example, a communication unit, a management unit, a storage unit, and the like. The management unit controls the communication unit by executing a management program stored in the storage unit in advance, and accordingly, a relay function between the movable body devices 1a, 1b, and 1c and the user devices 2a, 2b, and 2c is achieved.

The management server 3 may be omitted, if necessary. That is, the movable body devices 1a, 1b, and 1c may be directly communicated with the user devices 2a, 2b, and 2c without requiring the relay and the aid by the management server 3. The management server 3 is realized, for example, by a server device incorporated in a cloud computing system.

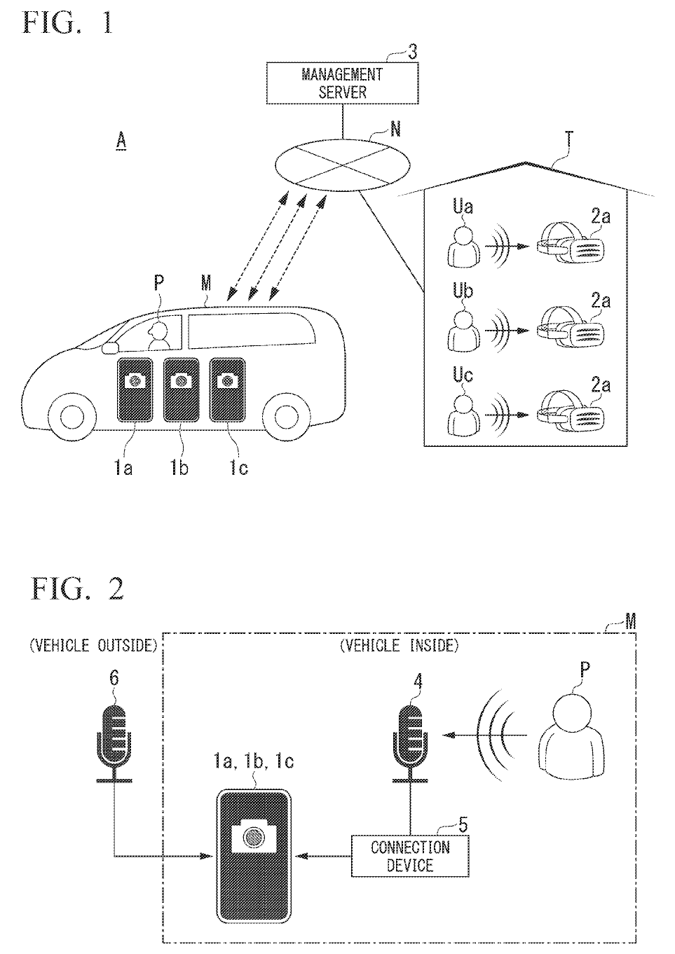

FIG. 2 is a block diagram showing a detailed configuration of the movable body M in the present embodiment. The movable body M includes an in-vehicle microphone 4, a connection device 5, and a vehicle outside microphone 6 in addition to each of the movable body devices 1a, 1b, and 1c. The in-vehicle microphone 4 and the connection device 5 are provided at a vehicle inside of the movable body M. The in-vehicle microphone 4 is connected to each of the movable body devices 1a, 1b, and 1c via the connection device 5. The in-vehicle microphone 4 captures a voice (occupant voice) of an occupant P and an environmental sound in a vehicle room and outputs the voice and the environmental sound to the connection device 5.

The connection device 5 is, for example, a device corresponding to an IVI (In-Vehicle Infotainment). The connection device 5 receives provision of information such as the occupant voice from the occupant P and provides various information to the occupant P. The connection device 5 outputs an in-vehicle sound such as the voice of the occupant P captured by the in-vehicle microphone 4 to each of the movable body devices 1a, 1b, and 1c.

The vehicle outside microphone 6 is provided on an outer portion (vehicle outside) of the movable body M, captures a sound (ambient sound) around the movable body M, and outputs the sound to each of the movable body devices 1a, 1b, and 1c. With respect to the ambient sound, an environmental sound at each point of the movable body M traveling on a predetermined route is provided to each of the users Ua, Ub, and Uc via each of the movable body devices 1a, 1b, and 1c.

That is, each of the movable body devices 1a, 1b, and 1c in the present embodiment not only distributes the movable body surrounding video as a distribution video to each of the user devices 2a, 2b, and 2c but also distributes the movable body voice as a distribution voice to each of the user devices 2a, 2b, and 2c. The movable body surrounding video (distribution video) and the movable body voice (distribution voice) are simulation experience information providing the drive simulation experience having a reality to each of the users Ua, Ub, and Uc.

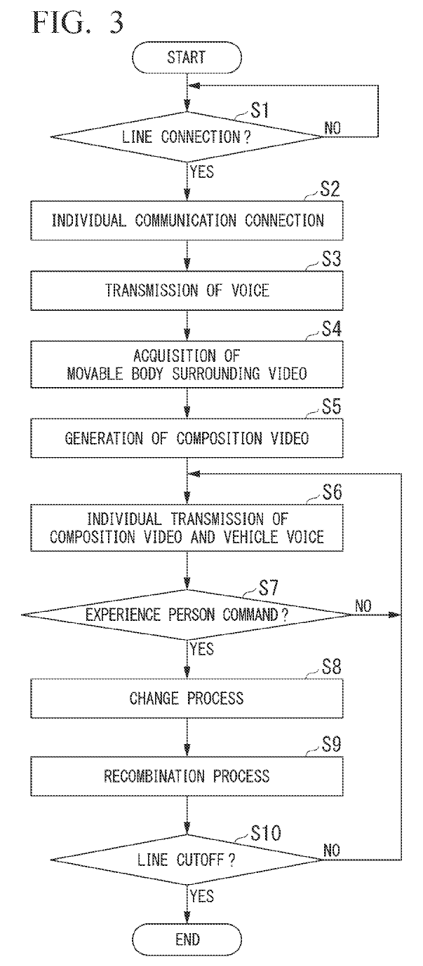

Next, an operation of the video distribution system A according to the present embodiment is described in detail along a flowchart shown in FIG. 3. This flowchart shows an operation of each of the movable body devices 1a, 1b, and 1c based on a video distribution program and shows the video distribution program and a video distribution method according to the present embodiment.

When a virtual drive experience by the movable body M using the video distribution system A is performed, each of the users Ua, Ub, and Uc who is present in the virtual drive experience place T transmits a connection request of a communication line provided on the movable body M, that is, a drive simulation experience request toward each of the movable body devices 1a, 1b, and 1c by using each of the user devices 2a, 2b, and 2c.

The drive simulation experience request of each of the users Ua, Ub, and Uc is transmitted to each of the movable body devices 1a, 1b, and 1c via the network N and the management server 3. When each of the movable body devices 1a, 1b, and 1c receives the connection request of the communication line (Step S1), each of the movable body devices 1a, 1b, and 1c performs an individual communication connection with each of the user devices 2a, 2b, and 2c via the network N (Step S2).

That is, the first movable body device 1a establishes a communication connection that uses a first individual line with each of the user devices 2a, 2b, and 2c. The second movable body device 1b establishes a communication connection that uses a second individual line with each of the user devices 2a, 2b, and 2c. The third movable body device 1c establishes a communication connection that uses a third individual line with each of the user devices 2a, 2b, and 2c.

When the first to third individual lines are established, the occupant P (streamer) recognizes the reception of the drive simulation experience request, for example, by notification by each of the movable body devices 1a, 1b, and 1c. Further, the occupant P (streamer) recognizes the reception of the drive simulation experience request by confirming an operation state of each of the movable body devices 1a, 1b, and 1c instead of the notification by the movable body devices 1a, 1b, and 1c.

Each of the movable body devices 1a, 1b, and 1c transmits, to each of the user devices 2a, 2b, and 2c, a voice informing each of the users Ua, Ub, and Uc of the start of the drive simulation experience (Step S3). When the voice transmission of Step S3 is completed, each of the movable body devices 1a, 1b, and 1c acquires a plurality of movable body surrounding videos (Step S4). That is, the first movable body device 1a acquires the first movable body surrounding video Ga, the second movable body device 1b acquires the second movable body surrounding video Gb, and the third movable body device 1c acquires the third movable body surrounding video Gc.

When the acquisition process of the movable body surrounding video of Step S4 is completed, each of the movable body devices 1a, 1b, and 1c individually distributes the first movable body surrounding video Ga, the second movable body surrounding video Gb, and the third movable body surrounding video Gc to each of the user devices 2a, 2b, and 2c via the individual line (Step S5). Further, each of the movable body devices 1a, 1b, and 1c acquires a movable body voice simultaneously with the first movable body surrounding video Ga, the second movable body surrounding video Gb, and the third movable body surrounding video Gc and individually distributes the movable body voice to each of the user devices 2a, 2b, and 2c via each individual line (Step S6).

Each of the user devices 2a, 2b, and 2c displays, on a screen, a composition video G of the movable body surrounding videos Ga, Gb, and Gc acquired from the movable body devices 1a, 1b, and 1c, respectively, and pronounces the movable body voice. When each of the user devices 2a, 2b, and 2c is a head-mounted display, the composition video G is displayed on a display surface of the head-mounted display worn by each of the users Ua, Ub, and Uc, and the movable body voice is pronounced from a sound generation portion of the head-mounted display.

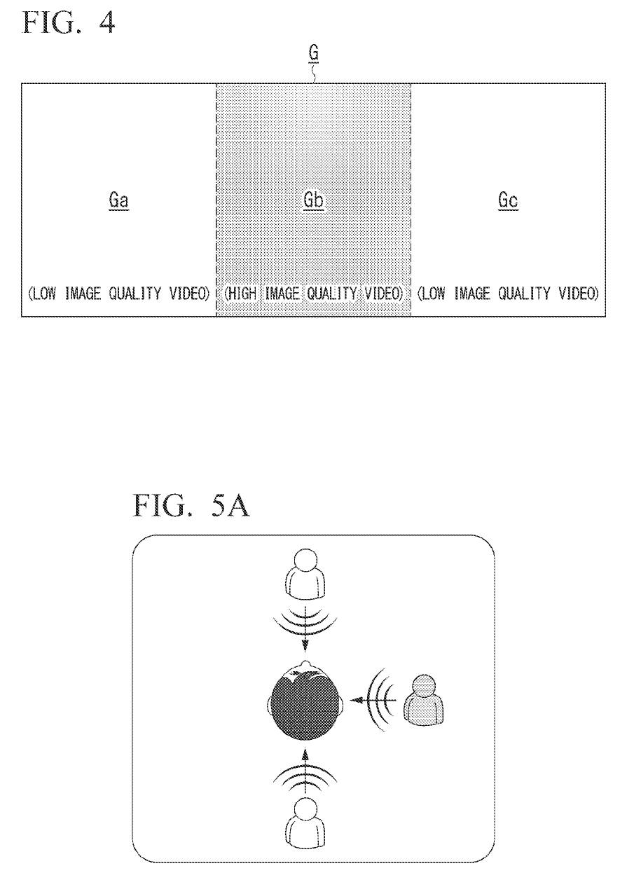

FIG. 4 is a schematic view showing an example of the composition video G. The composition video G is a panoramic video obtained by capturing the landscape around the movable body M at a wide angle. For example, the video is a 360° panoramic video over 360° around the movable body. As shown in FIG. 4, the movable body devices 1a, 1b, and 1c generate a composition video G (panoramic video) in which the first movable body surrounding video Ga, the second movable body surrounding video Gb, and the third movable body surrounding video Gc are arranged in this order from a left side to a right side.

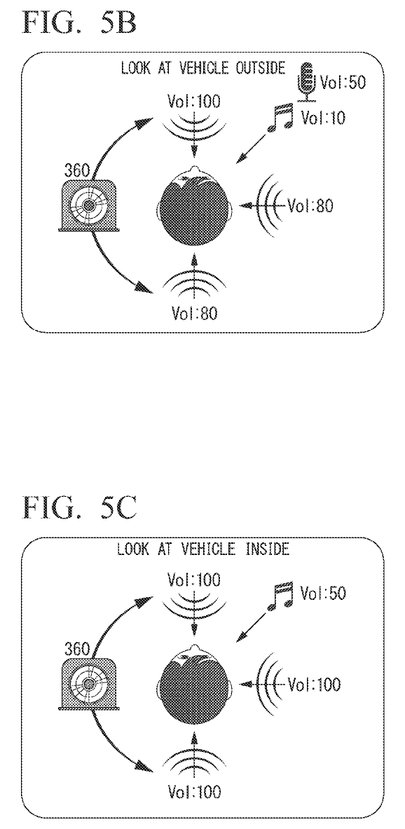

Here, a sound provided from each of the user devices 2a, 2b, and 2c to each of the users Ua, Ub, and Uc has a different sound image localization depending on a sound generation source of the sound as shown in FIG. 5A to FIG. 5C. Among the sounds provided to each of the users Ua, Ub, and Uc from each of the user devices 2a, 2b, and 2c, the voice of the occupant P (streamer) is provided to a right ear, and the voices of other users are provided from a front side or a rear side.

For example, as shown in FIG. 5A, among the sounds provided to the first user Ua from the first user device 2a, the voice of the occupant P (streamer) is provided to the right ear of the first user Ua, the voice of the second user Ub is provided from the front side, and the voice of the third user Uc is provided from the rear side. Accordingly, each of the users Ua, Ub, and Uc can accurately listen to and understand each sound in accordance with the sound generation source of the sound.

Further, the volume of the sound provided from each of the user devices 2a, 2b, and 2c to each of the users Ua, Ub, and Uc is adjusted in accordance with the movement of the head of each of the users Ua, Ub, and Uc. For example, as shown in FIG. 5B, when the first user Ua performs an operation of looking at the vehicle outside of the movable body M, the first user device 2a generates a sound of the ambient sound of the movable body M provided from the vehicle outside microphone 6. On the other hand, when the first user Ua performs an operation of looking at the vehicle inside of the movable body M, the first user device 2a blocks the sound generation of the ambient sound of the movable body M provided from the vehicle outside microphone 6 as shown in FIG. 5C.

As shown in FIG. 5B and FIG. 5C, the volume of the occupant voice when the ambient sound of the movable body M is generated from the first user device 2a is set to a lower volume than the volume of the occupant voice when the ambient sound of the movable body M is blocked. By such sound volume adjustment, each of the users Ua, Ub, and Uc can accurately listen to the movable body voice relating to the movable body surrounding video to which the user is paying attention.

In such a drive simulation experience, each of the users Ua, Ub, and Uc transmits an experience person command to each of the movable body devices 1a, 1b, and 1c by operating each of the user devices 2a, 2b, and 2c. When receiving the experience person command from each of the user devices 2a, 2b, and 2c (Step S7), each of the movable body devices 1a, 1b, and 1c performs a process in accordance with the experience person command. The experience person command is performed by inputting the voice (user voice) of each of the users Ua, Ub, and Uc to each of the user devices 2a, 2b, and 2c in addition to the movement of the head of each of the users Ua, Ub, and Uc described above.

For example, with respect to the movable body surrounding video displayed on each of the user devices 2a, 2b, and 2c (head-mounted displays), when each of the users Ua, Ub, and Uc performs a command of a change of a visual recognition direction by changing the direction of the head, the change command of the visual recognition direction is transmitted from each of the user devices 2a, 2b, and 2c to each of the movable body devices 1a, 1b, and 1c. Then, each of the movable body devices 1a, 1b, and 1c performs a change process of each movable body surrounding video in accordance with the change command of the visual recognition direction (Step S8).

The change process is a change of an imaging direction in accordance with the change command of the visual recognition direction. That is, each of the movable body devices 1a, 1b, and 1c changes the imaging direction of each movable body surrounding video in accordance with the change command of the visual recognition direction. When acquiring each of movable body surrounding videos Ga, Gb, and Gc that are newly acquired, each of the movable body devices 1a, 1b, and 1c determines whether or not the communication line (individual line) with each of the movable body devices 1a, 1b, and 1c is cut off (Step S10).

Then, when the determination of Step S10 is “No”, that is, when the communication line (individual line) with each of the movable body devices 1a, 1b, and 1c is maintained, each of the movable body devices 1a, 1b, and 1c transmits a new movable body surrounding video to each of the user devices 2a, 2b, and 2c together with the vehicle voice (Step S6).

When the determination process of Step S7 is “No”, that is, when the experience person command from each of the user devices 2a, 2b, and 2c is not received, each of the movable body devices 1a, 1b, and 1c repeats the process of Step S6. That is, each of the movable body devices 1a, 1b, and 1c distributes the composition video G and the vehicle voice to each of the user devices 2a, 2b, and 2c.

With respect to the change process of Step S8, the image quality of each movable body surrounding video may be changed in addition to the change of the imaging direction of each movable body surrounding video. For example, in the composition video G shown in FIG. 4, the second movable body surrounding video Gb is a movable body surrounding video located at a front in the visual recognition direction for each of the users Ua, Ub, and Uc. On the other hand, the first movable body surrounding video Ga and the third movable body surrounding video Gc are a movable body surrounding video located at an oblique angle in the visual recognition direction.

In consideration of such a positional relationship among the first movable body surrounding video Ga, the second movable body surrounding video Gb, and the third movable body surrounding video Gc, the image qualities of the first movable body surrounding video Ga and the third movable body surrounding video Gc that do not correspond to the front is decreased to be lower than the image quality of the second movable body surrounding video Gb that corresponds to the front. That is, in the plurality of movable body surrounding videos Ga, Gb, and Gc in the present embodiment, the image qualities may be identical to one another or may be different from one another.

The second movable body device 1b generates the second movable body surrounding video Gb as a high image quality video having a relatively high image quality. The first movable body device 1a generates the first movable body surrounding video Ga as a low image quality video having a relatively low image quality. Further, the third movable body device 1c generates the third movable body surrounding video Gc as a low image quality video having a relatively low image quality.

When the determination of Step S10 is “Yes”, that is, when the communication line (individual line) with each of the movable body devices 1a, 1b, and 1c is cut off, each of the movable body devices 1a, 1b, and 1c determines that the drive simulation experience request received in Step S1 is cancelled and ends all the processes.

The video distribution system A according to the present embodiment includes: a plurality of movable body devices 1a, 1b, and 1c mounted on a movable body M on which an occupant P boards; a plurality of user devices 2a, 2b, and 2c that are used by a plurality of users Ua, Ub, and Uc at a virtual drive experience place T (location) which is different from that of the movable body M; and a network N (communication network) that communicably connects each of the movable body devices 1a, 1b, and 1c to each of the user devices 2a, 2b, and 2c, and the video distribution system A distributes a movable body surrounding video from the movable body devices 1a, 1b, and 1c to the user devices 2a, 2b, and 2c, wherein the movable body devices 1a, 1b, and 1c acquire a plurality of movable body surrounding videos Ga, Gb, and Gc and distribute the movable body surrounding videos to the user devices 2a, 2b, and 2c by an individual line.

That is, the video distribution system A does not distribute a plurality of videos via a single communication as in the background art but distributes a plurality of movable body surrounding videos individually to each of the user devices 2a, 2b, and 2c by using an individual line. According to the present embodiment, it is possible to provide the video distribution system A that can prevent delay of the movable body surrounding video displayed at the plurality of user devices 2a, 2b, and 2c provided at a distributed side.

Further, in the video distribution system A according to the present embodiment, the movable body devices 1a, 1b, and 1c acquire a plurality of movable body surrounding videos Ga, Gb, and Gc in which an imaging direction does not overlap each other. According to the present embodiment, each of the users Ua, Ub, and Uc can visually recognize the movable body surrounding videos Ga, Gb, and Gc having a large imaging range.

Further, in the video distribution system A according to the present embodiment, the movable body devices 1a, 1b, and 1c performs a combination process of the plurality of movable body surrounding videos Ga, Gb, and Gc and acquire a composition video G. According to the present embodiment, each of the users Ua, Ub, and Uc visually recognizes the composition video G and can therefore have a drive simulation experience closer to an actual experience.

Further, in the video distribution system A according to the present embodiment, the plurality of movable body surrounding videos Ga, Gb, and Gc have an image quality that is identical to or different from each other. According to the present embodiment, each of the users Ua, Ub, and Uc visually recognizes the movable body surrounding videos Ga, Gb, and Gc having an image quality that is identical to or different from each other.

Further, in the video distribution system A according to the present embodiment, each of the user devices 2a, 2b, and 2c is a head-mounted display in which a visual recognition direction of the plurality of movable body surrounding videos Ga, Gb, and Gc is freely designated. According to the present embodiment, each of the users Ua, Ub, and Uc can have a drive simulation experience with a higher presence.

Further, in the video distribution system A according to the present embodiment, the movable body devices 1a, 1b, and 1c distribute the movable body surrounding video corresponding to the visual recognition direction acquired from the user devices 2a, 2b, and 2c (head-mounted displays). According to the present embodiment, each of the users Ua, Ub, and Uc can have a drive simulation experience in which the intention of the user is reflected.

Further, in the video distribution system A according to the present embodiment, the movable body devices 1a, 1b, and 1c are a plurality of smartphones to which an identical ID (identification number) is given. According to the present embodiment, the movable body devices 1a, 1b, and 1c can be easily realized by installing a distribution program to the smartphone.

Further, a video distribution method according to the present embodiment distributes a movable body surrounding video from a plurality of movable body devices 1a, 1b, and 1c mounted on a movable body M on which an occupant P boards to a plurality of user devices 2a, 2b, and 2c that are used by a plurality of users Ua, Ub, and Uc at a virtual drive experience place T (location) which is different from that of the movable body M, wherein the video distribution method includes: a step of acquiring a plurality of movable body surrounding videos Ga, Gb, and Gc; and a step of individually transmitting the plurality of movable body surrounding videos Ga, Gb, and Gc by using a plurality of individual lines.

The present embodiment does not distribute a plurality of videos via a single communication as in the background art but distributes a plurality of movable body surrounding videos individually to each of the user devices 2a, 2b, and 2c by using an individual line, and therefore, it is possible to provide the video distribution method that can prevent delay of the movable body surrounding video displayed at the plurality of user devices 2a, 2b, and 2c provided at a distributed side.

Further, a video distribution program according to the present embodiment causes a plurality of movable body devices 1a, 1b, and 1c (computer) mounted on a movable body M on which an occupant P boards to distribute a movable body surrounding video toward a plurality of user devices 2a, 2b, and 2c that are used by a plurality of users Ua, Ub, and Uc at a virtual drive experience place T (location) which is different from that of the movable body M, wherein the video distribution program causes the plurality of movable body devices 1a, 1b, and 1c (computer) to execute: a process of acquiring a plurality of movable body surrounding videos Ga, Gb, and Gc; and a process of individually transmitting the plurality of movable body surrounding videos Ga, Gb, and Gc by using a plurality of individual lines.

The present embodiment does not distribute a plurality of videos via a single communication as in the background art but distributes a plurality of movable body surrounding videos individually to each of the user devices 2a, 2b, and 2c by using an individual line, and therefore, it is possible to provide the video distribution program that can prevent delay of the movable body surrounding video displayed at the plurality of user devices 2a, 2b, and 2c provided at a distributed side.

The embodiment of the present invention has been described above, but the present invention is not limited to the embodiment described above. Various modifications and substitutions can be made without departing from the scope of the present invention. For example, in the embodiment described above, the present invention is applied to the drive simulation experience using the movable body M (automobile), but the present invention is not limited to this. For example, the present invention may be applied to a simulation experience using a movable body M other than an automobile. Further, the system configurations shown in FIG. 1 and FIG. 2 are merely examples of the present invention, and various modifications are conceivable.

What is claimed is:

1. A video distribution system that comprises: a plurality of movable body devices mounted on a movable body on which an occupant boards; a user device that is used by a user at a location which is different from that of the movable body; and a communication network that communicably connects the plurality of movable body devices to the user device, and distributes a video from the plurality of movable body devices to the user device,
wherein each of the plurality of movable body devices distributes a plurality of videos to the user device by an individual line, and
the user device performs a combination process of the plurality of videos distributed from the plurality of movable body devices and generates a composition video.

2. The video distribution system according to claim 1,
wherein the movable body devices acquire the plurality of videos in which an imaging direction does not overlap each other.

3. The video distribution system according to claim 1,
wherein the plurality of videos have an image quality that is identical to or different from each other.

4. The video distribution system according to claim 1,
wherein the user device is a head-mounted display in which a visual recognition direction is freely designated.

5. The video distribution system according to claim 4,
wherein the movable body devices distribute the video corresponding to the visual recognition direction acquired from the head-mounted display.

6. The video distribution system according to claim 4,
wherein the user device decreases an image quality of the video that does not correspond to a front to be lower than an image quality of the video that corresponds to the front based on the visual recognition direction acquired from the head-mounted display.

7. The video distribution system according to claim 1,
wherein the movable body devices are a plurality of smartphones to which an identical ID (identification number) is given.

8. The video distribution system according to claim 2,
wherein the plurality of videos have an image quality that is identical to or different from each other.

9. The video distribution system according to claim 2,
wherein the user device is a head-mounted display in which a visual recognition direction is freely designated.

10. The video distribution system according to claim 9,
wherein the movable body devices distribute the video corresponding to the visual recognition direction acquired from the head-mounted display.

11. The video distribution system according to claim 9,
wherein the user device decreases an image quality of the video that does not correspond to a front to be lower than an image quality of the video that corresponds to the front based on the visual recognition direction acquired from the head-mounted display.

12. The video distribution system according to claim 2,
wherein the movable body devices are a plurality of smartphones to which an identical ID (identification number) is given.

13. A video distribution method that distributes a video from a movable body device mounted on a movable body on which an occupant boards to a user device that is used by a user at a location which is different from that of the movable body, the video distribution method comprising:
acquiring a plurality of videos; and
individually transmitting the plurality of videos by using a plurality of individual lines.

14. A computer-readable non-transitory storage medium storing a video distribution program that causes a computer mounted on a movable body on which an occupant boards to distribute a video toward a user device that is used by a user at a location which is different from that of the movable body,
wherein the video distribution program causes the computer to execute:
acquiring a plurality of videos; and
individually transmitting the plurality of videos by using a plurality of individual lines.
